(19) United States
(12) Patent Application Publication
(10) Pub. No.: US 2009/0063542 A1
(43) Pub. Date: Mar. 5, 2009

(54) Cluster Presentation of Digital Assets for Electronic Devices

(76) Inventors: William E. BULL, Campbell, CA (US); Policarpo WOOD, Cupertino, CA (US); Benjamin A. ROTTLER, Burlingame, CA (US); Kourtny Minh HICKS, Sunnyvale, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 11/849,960

(22) Filed: Sep. 4, 2007

(51) Int. Cl. G06F 17/30; G06F 3/048

(52) U.S. Cl. 707/102; 715/790; 715/781; 707/E17.005

(57) ABSTRACT

Improved approaches to present groups of digital assets in a dynamic, graphical manner are disclosed. The groups to be presented can be automatically formed in accordance with grouping criteria. Each of the resulting groups can then be visually represented by a set of images. The sets of images for the different groups can be dynamically visually presented in a sequential manner. The plurality of images that represent a particular group can be concurrently presented in a partial overlapped arrangement. Optionally, user interaction can affect the group(s) being presented, alter the images visually representing the group(s), or cause other navigational actions with respect to the digital assets. The presentation of the groups (e.g., clusters) can serve to assist a user in understanding what digital assets (e.g., digital media assets) are available on an electronic device. The electronic device typically permits the user to utilize (e.g., play, view, etc.) the digital assets.

### BACKGROUND OF THE INVENTION

1. Field of the Invention

The present invention relates to mobile electronic devices and, more particularly, to presentation of groups of digital assets for mobile electronic devices.

2. Description of the Related Art

Today, electronic devices, such as personal computers, media players and cameras, can often display names of audio tracks (e.g., songs), videos (e.g., movies) or photos (e.g., images) that are stored on such electronic devices. However, as collections of media stored to electronic devices become larger and more diverse, navigating such collections has become more tedious. List-based navigation using a hierarchy of menus, such as described in U.S. Pat. No. 7,166,791, are effective but are text based and require user interaction. Accordingly, there remains a need to develop new and different approaches to browse or navigate media collections.

### SUMMARY OF THE INVENTION

The invention relates to presentation of groups of digital assets in a dynamic, graphical manner. The groups to be presented can be automatically formed in accordance with grouping criteria. Each of the resulting groups can then be visually represented by a set of images. The sets of images for the different groups can be dynamically visually presented in a sequential manner. The plurality of images that represent a particular group can be concurrently presented in a partial overlapped arrangement. Optionally, user interaction can affect the group(s) being presented, alter the images visually representing the group(s), or cause other navigational actions with respect to the digital assets.

The invention is particularly useful for digital assets, such as digital media assets, that have an associated graphical representation (e.g., image). The groups of digital assets being presented can be referred to as clusters. The presentation of the groups (e.g., clusters) can serve to assist a user in understanding what digital assets (e.g., digital media assets) are available on an electronic device. The electronic device typically permits the user to utilize (e.g., play, view, etc.) the digital assets. The invention is also useful for displaying information on mobile electronic devices that necessarily have displays with limited display area.

The invention can be implemented in numerous ways, including as a method, system, device, or apparatus (including graphical user interface and computer readable medium). Several embodiments of the invention are discussed below.

As an electronic system, one embodiment of the invention can include at least: a memory configured to store a plurality of digital media assets; a user input device configured to receive a user input; a display device configured to present media information; and a processing unit. The processing unit can be configured to: present any of the digital media assets in response to a user input received via the user input device, arrange the digital media assets into groups of at least two of the digital media assets, and cause the display device to present the groups of the digital media assets, wherein visual representations associated with a plurality of the digital media assets within each of the groups are at least partially displayed in a concurrent fashion with partial overlap.

As a method for forming media asset clusters presenting digital assets on a display associated with an electronic device, one embodiment of the invention can include at least the acts of: identifying a plurality of available digital assets; obtaining cluster attributes; and forming media asset clusters from the media asset files based on the cluster attributes, each of the media asset clusters having more than one of the digital assets.

As a method for importing digital media assets to an electronic device, one embodiment of the invention can include at least the acts of: receiving digital media assets being imported to the electronic device; automatically associating the received digital media assets to media asset clusters, thereby determining cluster information; and storing the imported digital media assets and the cluster information to the electronic device.

As a method for presenting digital media assets on a display associated with a computing device, one embodiment of the invention can include at least the acts of: identifying a plurality of media assets corresponding to a plurality of media assets files stored on the computing device; obtaining cluster attributes; forming media asset clusters from the media assets based on the cluster attributes, each of the media asset clusters corresponding to more than one of the media assets; determining a presentation format for the media asset clusters; and dynamically presenting the media asset clusters in accordance with the presentation format respectively associated with the media asset clusters.

As a computer readable medium including at least executable computer program code tangibly stored thereon for presenting digital media assets on a display associated with an electronic device, one embodiment of the invention can include at least: computer program code for identifying a plurality of media assets corresponding to a plurality of media assets files stored on the computing device; computer program code for obtaining cluster attributes; computer program code for forming media asset clusters from the media assets based on the cluster attributes, each of the media asset clusters corresponding to more than one of the media assets; computer program code for determining a presentation format for the media asset clusters; and computer program code for dynamically presenting the media asset clusters in accordance with the presentation format respectively associated with the media asset clusters.

As a method for displaying information on digital assets, one embodiment of the invention can include at least the acts of: identifying a plurality of clusters to be displayed, each of the clusters corresponding to a plurality of digital assets; selecting one of the clusters to be displayed; displaying an initial representation of the selected cluster; determining, following the displaying, whether another representation of the selected cluster should be displayed; displaying the another representation of the selected cluster if it is determined that the another representation of the selected cluster should be displayed.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a flow diagram of a cluster presentation process according to one embodiment of the invention.

FIG. 2 is a block diagram of a cluster formation system according to one embodiment of the invention.

FIG. 3 is a block diagram of an electronic device according to one embodiment of the invention.

FIG. 4 is a flow diagram of a cluster formation process according to one embodiment of the invention.

FIG. 5 is a flow diagram of an import process according to one embodiment of the invention.

FIG. 6 is a flow diagram of a cluster presentation process according to one embodiment of the invention.

FIG. 7 is a flow diagram of a cluster display process according to one embodiment of the invention.

FIGS. 8A-8D illustrate several exemplary cluster arrangements suitable for displaying a cluster associated with a media collection.

FIG. 9 is a block diagram of a mobile multi-function device according to one embodiment of the invention.

### DETAILED DESCRIPTION OF THE INVENTION

The invention relates to presentation of groups of digital assets in a dynamic, graphical manner. The groups to be presented can be automatically formed in accordance with grouping criteria. Each of the resulting groups can then be visually represented by a set of images. The sets of images for the different groups can be dynamically visually presented in a sequential manner. The plurality of images that represent a particular group can be concurrently presented in a partial overlapped arrangement. Optionally, user interaction can affect the group(s) being presented, alter the images visually representing the group(s), or cause other navigational actions with respect to the digital assets.

The invention is particularly useful for digital assets, such as digital media assets, that have an associated graphical representation (e.g., image). The groups of digital assets being presented can be referred to as clusters. The presentation of the groups (e.g., clusters) can serve to assist a user in understanding what digital assets (e.g., digital media assets) are available on an electronic device. The electronic device typically permits the user to utilize (e.g., play, view, etc.) the digital assets. The invention is also useful for displaying information on mobile electronic devices that necessarily have displays with limited display area.

The presentation of a group of digital assets can serve to highlight or emphasize certain of the digital assets within the group. The highlighted or emphasized digital assets within the group can automatically or manually change to focus on other digital assets within the group. Since there are typically multiple different groups of digital assets, different ones of the groups can automatically or manually be presented. In one implementation, presentations for different groups can be periodically changed in an automated manner. For example, different groups can be sequentially presented. Although no user interaction is needed for presentation of different groups, user interaction can optionally be provided to (i) stop, pause, slow, speed-up or otherwise alter the presentation of the different groups, or (ii) change focus onto other digital assets within a particular group.

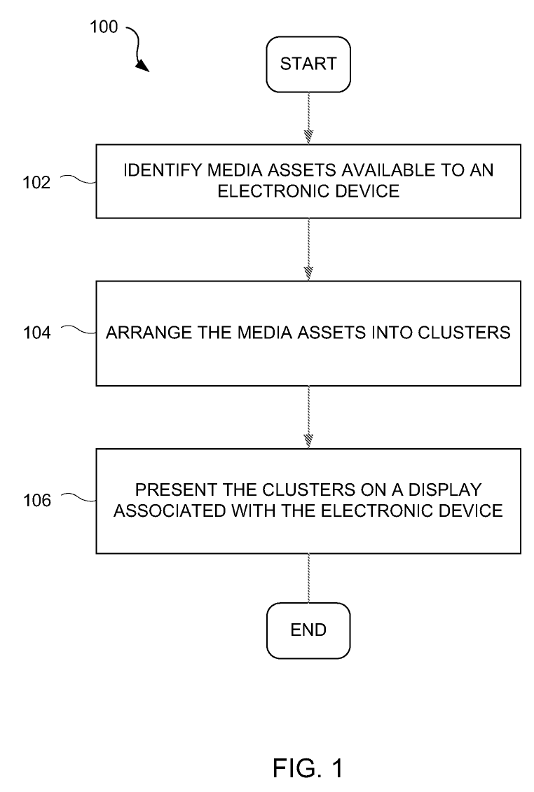

Embodiments of the invention are discussed below with reference to FIGS. 1-9. However, those skilled in the art will readily appreciate that the detailed description given herein with respect to these figures is for explanatory purposes as the invention extends beyond these limited embodiments.

FIG. 1 is a flow diagram of a cluster presentation process 100 according to one embodiment of the invention. The cluster presentation process 100 identifies 102 media assets that are available to an electronic device. The media assets can then be arranged 104 into clusters. Clusters are groupings or sets of digital assets, such as digital media assets. After the media assets have been arranged 104 into clusters, the clusters can be presented 106 on a display associated with the electronic device. The presentation of the clusters on the display can vary depending upon implementation. For example, in one implementation, the clusters can be dynamically presented on the display in a sequential manner. In this regard, one cluster can be presented on the display for a period of time and then a subsequent cluster can thereafter be presented on the display in place of the previous cluster.

Presentation of a cluster typically involves display of one or more visual representations of the cluster or a subset of the digital assets assigned to the cluster. The transitioning from presenting one cluster to another cluster can be animated to provide a transition effect. Various transition effects can be used. One example of a transition effect is to slide a next cluster representation onto the display while sliding a current cluster representation off of the display.

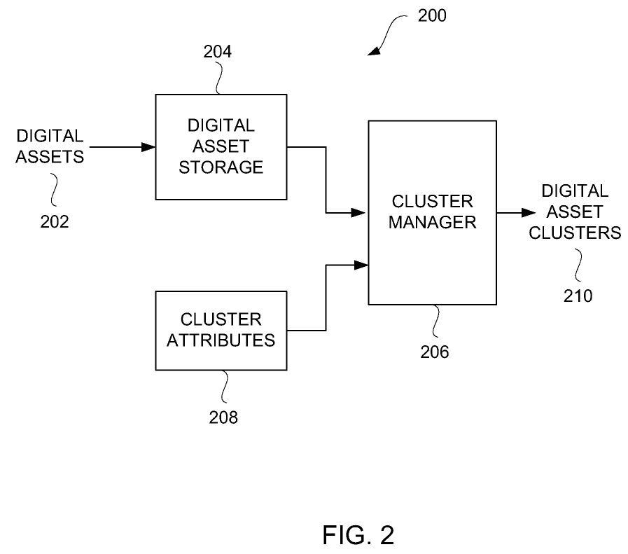

FIG. 2 is a block diagram of a cluster formation system 200 according to one embodiment of the invention. The cluster formation system 200 receives digital assets 202. These digital assets 202 are provided in electronic data files. The digital assets 202 can pertain to audio, video, images or any combination thereof. Examples of digital assets 202 are songs, movies, podcast, TV shows, audio books, etc.

The cluster formation system 200 includes digital asset storage 204. The digital asset storage 204 receives the digital assets 202. Typically, the digital asset storage 204 resides within an electronic device. For example, the digital asset storage 204 can pertain to non-volatile memory, such as Flash memory or a disk storage device. The cluster formation system 200 also includes a cluster manager 206. The cluster manager 206 operates to form clusters from the various digital assets 202 that are stored in the digital asset storage 204. In doing so, the cluster manager 206 makes use of cluster attributes 208. The cluster attributes 208 are criteria used to arrange the digital assets 202 into clusters. The cluster manager 206 outputs digital asset clusters 210.

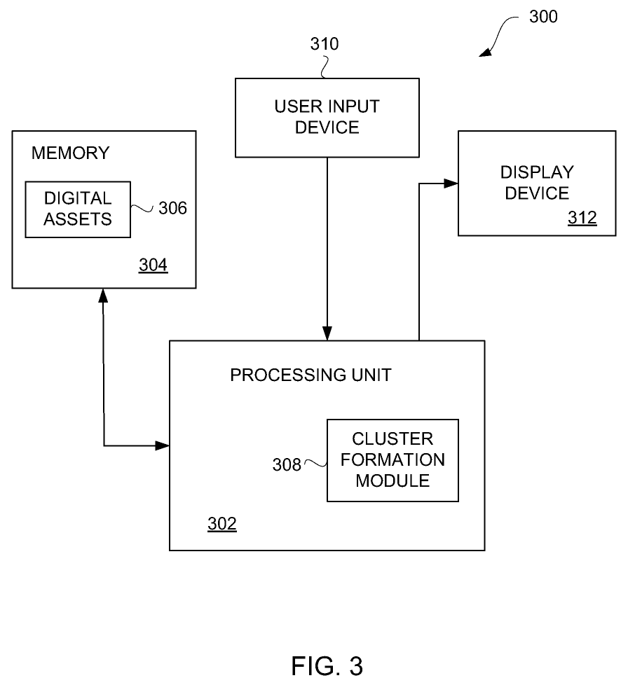

FIG. 3 is a block diagram of an electronic device 300 according to one embodiment of the invention. The electronic device 300 can include a processing unit 302 that controls operation of the electronic device 300. The processing unit 302 couples to a memory 304. The memory 304 can store data for use by the electronic system 300. Among other things, the memory 304 can store digital assets 306. For example, the digital assets 306 can pertain to digital media assets within a media library. The processing unit 302 can include or be configured to provide a cluster formation module 308 which can be implemented in software and/or hardware. The cluster formation module 308 can implement a cluster formation system to form clusters of digital assets. As an example, the cluster formation module 308 can implement the cluster formation system 200 illustrated in FIG. 2. The electronic device can further include input/output devices, such as a user input device 310 and a display device 312. Representations of the clusters of the digital assets 306 that can be formed by the cluster formation module 308 can be displayed on the display device 312.

In one embodiment, the electronic device is a mobile electronic device that is normally powered by one or more batteries. With mobile electronic device, the display size is limited because the electronic device must remain small so as to be easily transported. For example, the display is normally not more than fifteen (15) centimeters in any one direction, and are frequently not more than ten (10) centimeter in any one direction. With small scale displays, presenting available digital assets, such as digital media, can be challenging. Also navigation of available digital assets via such devices can require significant user interaction.

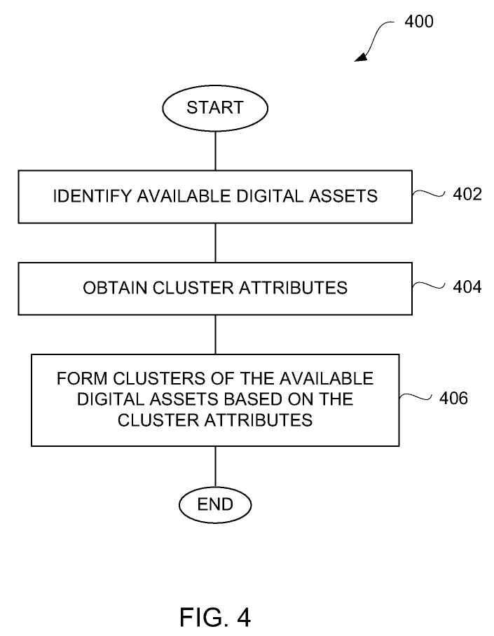

FIG. 4 is a flow diagram of a cluster formation process 400 according to one embodiment of the invention. The cluster formation process 400 can identify 402 available digital assets. Cluster attributes can also be obtained 404. Then, clusters of the available digital assets can be formed 406 based on the cluster attributes. Following the block 406, the cluster formation process 410 end.

Digital assets can pertain to media items, such as albums, songs, videos, podcasts, audio books, or games. Groups of digital assets, referred to as clusters, can be formed in various ways using a variety of attributes (or criteria). The attributes, also known as cluster attributes, are used to group (or cluster) the various digital assets. A cluster can represent a grouping of digital assets pertaining to an event. An event can be user-defined, predetermined, or provided by other means. For example, another device can establish an event for certain digital assets. A cluster can also represent a grouping of digital assets pertaining to a time period or location. For example, a time period for a cluster can be daily, a range or days, monthly or yearly. A cluster can represent a grouping of digital assets pertaining to a classification. The classification can, for example, depend on one or more of: type (media type), size, source, date, time or user. Examples of sources for digital assets can concern how the digital assets was provided to an electronic device, such as via memory card, via network (e.g., WiFi, Internet, peer-to-peer), or via host computer (e.g., during synchronization). The attributes for grouping digital assets can include one or more events, time periods, locations or classifications.

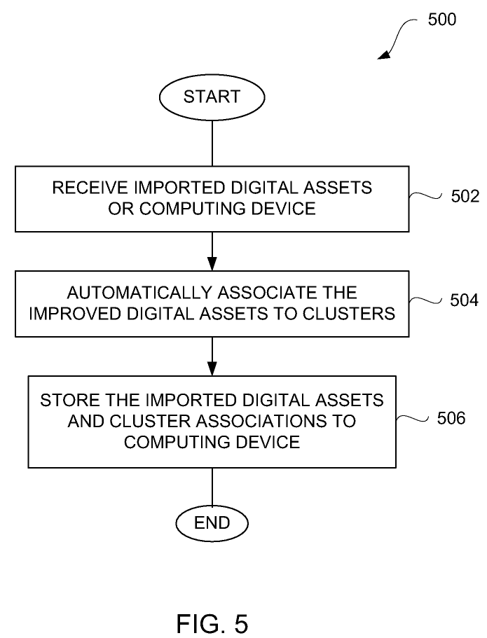

FIG. 5 is a flow diagram of an import process 500 according to one embodiment of the invention. The import process 500 can be performed by an electronic device, such as a computing device (e.g., personal computer). The import process 500 receives 502 imported digital assets at the computing device. After the imported digital assets have been received 502, the imported digital assets can be automatically associated 504 to clusters. Based on characteristics of the imported digital assets, the imported digital assets can be automatically associated 504 to clusters. For example, predetermined cluster attributes can be used to associate the imported digital assets to clusters. The imported digital assets and cluster associations can be stored to the computing device for subsequent usage.

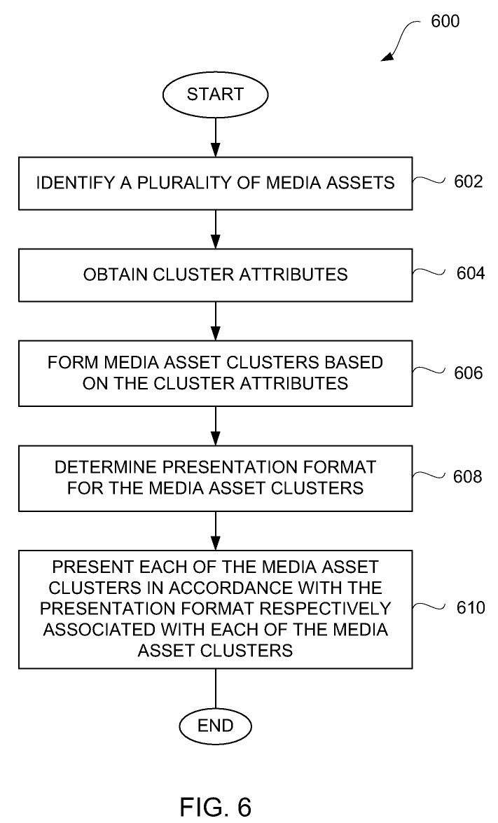

FIG. 6 is a flow diagram of a cluster presentation process 600 according to one embodiment of the invention. The cluster presentation process 600 operates to present one or more clusters at an output device (e.g., display device).

The cluster presentation process 600 can identify 602 a plurality of media assets. Cluster attributes to be utilized to form clusters of the media assets can be obtained 604. Media asset clusters can then be formed 606 based on the cluster attributes. A presentation format for the media asset clusters can then be determined 608. The presentation format specifies or identifies an arrangement for presentation of the media asset clusters. In one embodiment, at least some of the presentation formats present images associated with media assets within a media asset cluster in a partially overlapped manner. By partially overlapping the images associated with different media assets, the display is able to display information more efficiently and effectively, which is particularly helpful with electronic devices having limited display area. After the media asset clusters are formed 606 and the presentation format to be used determined 608, the media asset clusters can be presented 610. For a given cluster, the cluster can be presented 610 in accordance with the presentation format respectively associated with that media asset cluster. The presentation 610 of the media asset clusters can be performed sequentially, with one media asset cluster followed by another. Following the block 610, the cluster presentation process 600 can end.

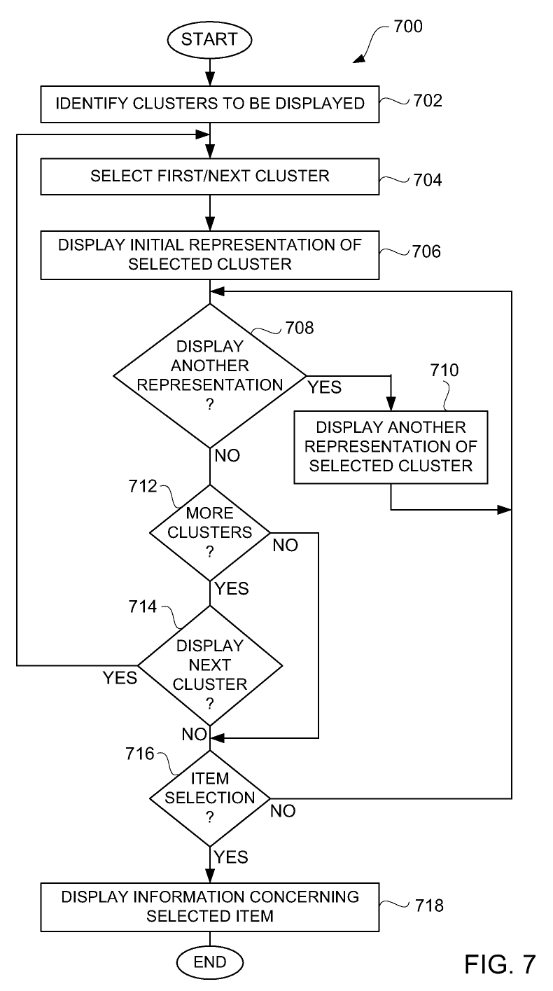

FIG. 7 is a flow diagram of a cluster display process 700 according to one embodiment of the invention. The cluster display process 700 can identify 702 clusters to be displayed. Here, the clusters to be displayed are clusters that have been previously determined and are now to be presented, e.g., displayed, on a display associated with an electronic device. After the clusters to be displayed have been identified 702, a first cluster can be selected 704. An initial representation of the selected cluster can then be displayed 706. For example, the initial representation can be a first set of graphical images associated with the selected cluster. More specifically, if the selected cluster pertains to music, the graphical images can pertain to artwork associated with the music within the selected cluster.

Next, a decision 708 determines whether another representation of the selected cluster should be displayed. The decision 708 can be initiated automatically or in response to user interaction with the electronic device. Another representation of the selected cluster can, for example, pertain to different digital assets within the selected cluster. In one implementation, the initial representation can be a first set of graphical images associated with the selected cluster, and the another representation can be a second set of graphical images associated with the selected cluster. The different digital assets within the selected cluster can often be associated with different graphical images. Hence, the different representations associated with the selected cluster can pertain to different graphical images that correspond or associate to the digital assets within the selected cluster.

When the decision 708 determines that another representation of the selected cluster is to be displayed, the another representation of the selected cluster is displayed 710. Following the block 710, the cluster display process 700 can return to repeat the decision 708 to again evaluate whether another representation of the selected cluster should be displayed. Hence, for a given selected cluster, various different representations can be displayed.

When the decision 708 determines that another representation of the selected cluster is not to be displayed, a decision 712 can determine whether there are more clusters to be processed. When the decision 712 determines that there are more clusters to be processed, a decision 714 can determine whether a next cluster is to be displayed. The decision 714 can be initiated automatically (e.g., such as after a period of time) or in response to user interaction with the electronic device. When the decision 714 determines that a next cluster should be displayed, the cluster display process 700 returns to repeat the block 704 so that a next cluster can be selected.

Alternatively, when the decision 714 determines that a next cluster is not to be displayed, or following the block 712 when there are no more clusters to be processed, a decision 716 can determine whether an item within the displayed cluster has been selected. When the decision 716 determines that an item selection has not been made with respect to the displayed cluster, the cluster display process 700 can return to repeat the decision 708 and subsequent blocks so that the clusters can continue to be processed. On the other hand, once the decision 716 determines that an item selection has been made with respect to the displayed cluster, information concerning the selected item can be displayed 718. The information concerning the selected item can vary depending upon implementation. Typically, the item selection can be user activated and the information concerning the selected item can be information descriptive of the particular item that has been selected. For example, if the item being selected is a media item, the information being displayed can be textual and/or image data that pertains to the media item. For example, metadata and artwork associated with the media item can be displayed. Additionally, the item selection could also facilitate or begin playback of the media item.

A media library is typically resident on an electronic device. The electronic device can receive data for the various digital assets that make up the media library in various ways, such as, over a network connection, from a host computer, or from a portable memory device (e.g., memory card, compact disc).

For example, assume that a media library includes three media collections, media collection A, media collection B and media collections C. Each of these media collections includes a plurality of digital media assets referred to as items (or media items). Accordingly, each of the media collections (e.g., groups, sets or clusters) includes a plurality of items, namely, digital media assets. For example, media collection A can include media items A1, A2, A3, . . . , Ax; media collection B can include media items B1, B2, B3, . . . , By; and media collection C can include media items C1, C2, C3, . . . , Cz. Given that these media collections include a substantial number of media items, presentation of the contents (e.g., media collections) of the media library can be intelligently performed so that users can understand the general contents of media collections. In one embodiment, one or more representations of particular media items of a collection can be displayed. Different media collections can present different representations for the different media collections.

The characteristics and/or arrangements of the collections being displayed can vary depending upon the nature, type, size or other characteristic of a media collection.

According to one embodiment, when a plurality of representations for a cluster are presented, at least some of the representations can be partially overlapped. It should be noted that in the case of a mobile electronic device, the available screen display area is limited. As a result, by being able to overlap a portion of the representations for a cluster, cluster representations can be displayed on mobile electronic devices in a compact and informative manner.

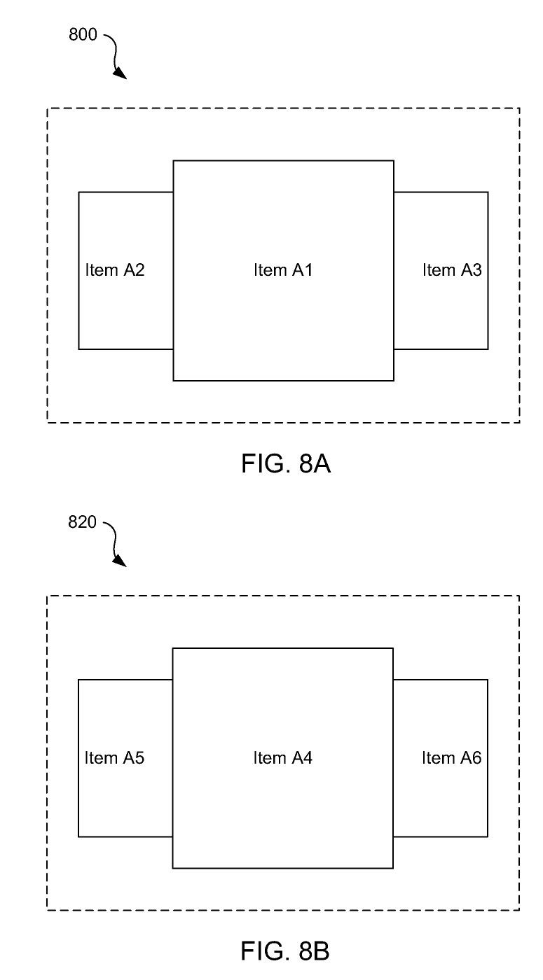

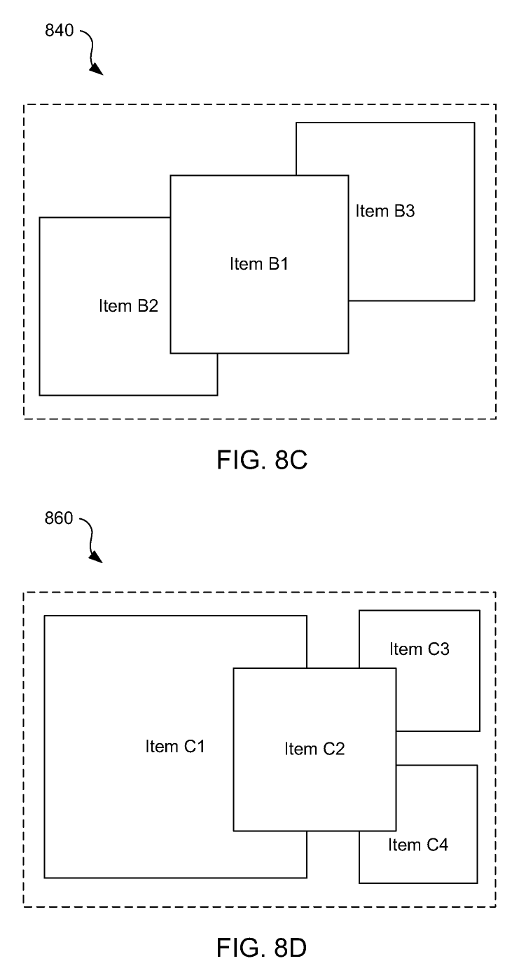

FIGS. 8A-8D illustrate several exemplary cluster arrangements suitable for displaying a cluster associated with a media collection. The exemplary cluster arrangements are displayed with reference to a display area (see dotted line) of a display.

FIG. 8A is a diagram illustrating an exemplary cluster 800 according to one embodiment of the invention. The exemplary cluster 800 is a group of items (e.g., media items) that includes at least items A1, A2 and A3. The exemplary cluster 800 presents a primary item A1 and secondary items A2 and A3. For each of the items A1, A2 and A3, an associated image is displayed by the exemplary cluster 800. Note that the exemplary cluster 800 presents an image corresponding to the item A1 in a larger viewing area. In one embodiment, the larger viewing area is utilized to display an image that is representative of the exemplary cluster 800 or is most likely or most often recognizable as corresponding to the item A1. For the secondary items A2 and A3, corresponding images can be displayed in smaller viewing areas.

FIG. 8B is a diagram illustrating an exemplary cluster 820 according to one embodiment of the invention. The exemplary cluster 820 has the same arrangement as does the exemplary cluster 800 illustrated in FIG. 8A. however, the exemplary cluster 820 illustrated in FIG. 8B represents a subsequent representation of the exemplary cluster 800 wherein a new set of items, namely, items A4, A5 and A6, that are displayed as part of the exemplary cluster 820. It should be noted that the items A4, A5 and A6 are part of the group of items being represented by the exemplary clusters illustrated in FIGS. 8A and 8B. Hence, after the exemplary cluster 800 illustrated in FIG. 8A has been displayed for a predetermined period of time or in response to a user input, the exemplary cluster 800 can be updated to an updated exemplary cluster 820. The updated exemplary cluster has the same format as the exemplary cluster 800, but the representation of the updated exemplary cluster 820 differs from the representation of the exemplary cluster 800. In particular, the updated exemplary cluster 800 presents an image corresponding to the item A4 in the larger viewing area, and presents images corresponding to the items A5 and A6 in the smaller viewing areas.

Alternatively, in one embodiment, user interaction with the exemplary cluster 800 illustrated in FIG. 8A can effect which of the items A1, A2 or A3 is the primary item. For example, a user interaction could cause item A2 to become the primary item and items A2 and A3 to become secondary items.

FIG. 8C is a diagram illustrating an exemplary cluster 840 according to one embodiment of the invention. The arrangement of the media items within the exemplary cluster 840 is different than the arrangement utilized with the exemplary clusters 800 and 820 illustrated in FIGS. 8A and 8B. The exemplary cluster 840 presents a primary viewing area and a pair of secondary viewing areas. In this example, the size of the primary view area and the secondary viewing areas are substantially the same size. An image corresponding to item B1 can be presented in the primary viewing area. Images corresponding to items B2 and B3 can be respectively presented in the secondary viewing areas.

FIG. 8D is a diagram illustrating an exemplary cluster 860 according to still another embodiment of the invention. The arrangement of the media items within the exemplary cluster 840 is different than the arrangements utilized with the exemplary clusters illustrated in FIGS. 8A, 8B and 8C. In particular, the arrangement for the exemplary cluster 860 includes an arrangement of four representations of specific items, namely, items C1, C2, C3 and C4, within the exemplary cluster 860. For the exemplary cluster 860, the representation for item C2 partially overlaps a portion of the representations for items C1, C3 and C4. The exemplary cluster 860 also uses three different sizes of representations so as to efficiently utilize the available display screen.

The various images being displayed in the exemplary cluster arrangements illustrated in FIGS. 8A-8D can be displayed with one or more visual effects. The visual effect can, for example, operate to skew, scale, or distort the images. As one example, below each image can be displayed a reflected version of the image which itself can be skewed, scaled or distorted.

In one embodiment, a primary item can be displayed such that it appear closest to the top surface of the display device, and secondary items can be displayed to appear to be behind the primary item. In another embodiment, the size of a cluster can be dependent on the number of items within the displayed cluster. Also, with a larger cluster, the cluster can be displayed such that it appears deeper into the display (such as be making the individual items smaller with or without some perspective distortion).

Transitioning either intra-cluster or between clusters can utilize a transition effect. In one embodiment, a transition effect yields a smooth transition intra-cluster. In one implementation, the primary item can be displayed such that it appears closest to the top surface of the display device, and the secondary items can be displayed to appear to be behind the primary item. With an intra-cluster transition, a secondary item (that is transitioning to the primary item) can move to appear closer to the top surface of the display device and the primary image (that is transitioning to the secondary item) can move down behind the secondary item. Between cluster transitions can be achieved by sliding the current cluster off-screen while sliding a new cluster on-screen, such as, for example, a parade across the display.

Additional detail on transitioning and various other aspects of graphical user interfaces can be found in the following: (i) U.S. patent application Ser. No. ______ [Att. Dkt. No.: APPL:007-P5695US1], filed Sep. 4, 2007 and entitled “IMAGE ANIMATION WITH TRANSITIONAL IMAGES,” which is hereby incorporated herein by reference for all purposes; (ii) U.S. patent application Ser. No. ______ [Att. Dkt. No.: APPL:009-P5793US1], filed Sep. 4, 2007 and entitled “ANTI-ALIASING OF A GRAPHICAL OBJECT,” which is hereby incorporated herein by reference for all purposes; and (iii) U.S. patent application Ser. No. ______ [Att. Dkt. No.: APPL:009-P5739US1], filed Sep. 4, 2007 and entitled “USER INTERFACE ELEMENTS CLONING AND TRANSITIONS,” which is hereby incorporated herein by reference for all purposes.

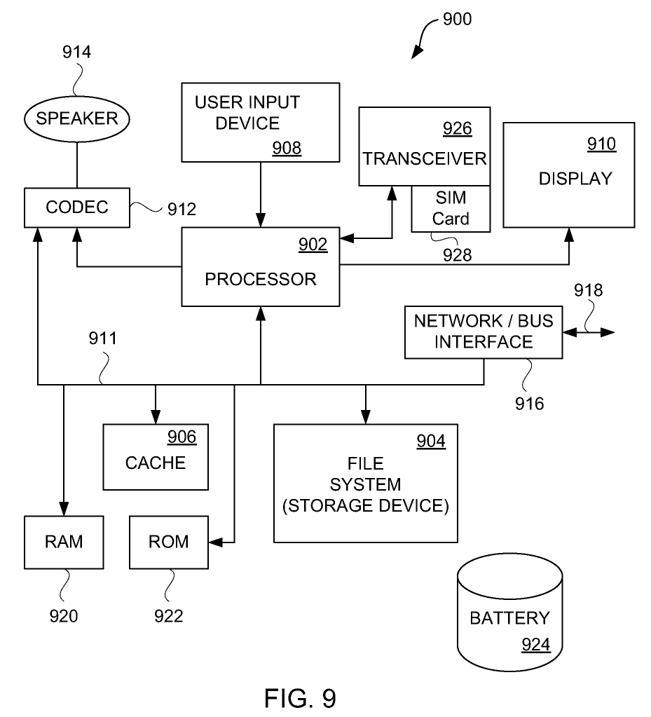

FIG. 9 is a block diagram of a mobile multi-function device 900 according to one embodiment of the invention. The mobile multi-function device 900 can include the circuitry of a portable electronic device that can perform the operations described with reference to FIGS. 1 and 4-7, the system 200 illustrated in FIG. 2 or the device 300 illustrated in FIG. 3. The mobile multi-function device 900 includes hardware and software components to provide at least two functions, namely, a media playback function and a wireless voice communications function. When providing media playback, the mobile multi-function device 900 can operate as a media player capable of playing (including displaying) media items. The media items can, for example, pertain to audio items (e.g., audio files or songs), videos (e.g., movies) or images (e.g., photos). When providing wireless voice communications, the mobile multi-function device 900 can operate a mobile telephone (e.g., cellular phone).

The mobile multi-function device 900 includes a processor 902 that pertains to a microprocessor or controller for controlling the overall operation of the mobile multi-function device 900. The mobile multi-function device 900 stores media data pertaining to media items in a file system 904 and a cache 906. In one embodiment, the file system 904 is implemented by a storage disk or a plurality of disks. In another embodiment, the file system 904 is implemented by EEPROM or Flash type memory. The file system 904 typically provides high capacity storage capability for the mobile multi-function device 900. However, since the access time to the file system 904 is relatively slow, the mobile multi-function device 900 can also include a cache 906. The cache 906 is, for example, Random-Access Memory (RAM) provided by semiconductor memory. The relative access time to the cache 906 is substantially shorter than for the file system 904. However, the cache 906 does not have the large storage capacity of the file system 904. Further, the file system 904, when active, consumes more power than does the cache 906. The power consumption is often a concern when the mobile multi-function device 900 is a portable mobile multi-function device that is powered by a battery 924. The mobile multi-function device 900 also includes a RAM 920 and a Read-Only Memory (ROM) 922. The ROM 922 can store programs, utilities or processes to be executed in a non-volatile manner. The ROM 922 can be implemented by an EEPROM or Flash type memory so as to provide writable non-volatile data storage. The RAM 920 provides volatile data storage, such as for the cache 906.

In one embodiment, to support wireless voice communications, the mobile multi-function device 900 includes a transceiver 926 and a SIM card 928. The transceiver 926 supports wireless communication with a wireless network (such as a wireless cellular network). The SIM card 928 includes an identifier (e.g., SIM identifier) can be used by the mobile multi-function device 900 to gain access and utilize the wireless network. In other embodiments, a SIM card 928 is not utilized.

The mobile multi-function device 900 also includes a user input device 908 that allows a user of the mobile multi-function device 900 to interact with the mobile multi-function device 900. For example, the user input device 908 can take a variety of forms, such as a button, keypad, dial, etc. Still further, the mobile multi-function device 900 includes a display 910 (screen display) that can be controlled by the processor 902 to display information to the user. The user input device 908 can also be implemented as a touch-sensitive device apart or integral with the display 910. A data bus 911 can facilitate data transfer between at least the file system 904, the cache 906, the processor 902, and the CODEC 912.

In one embodiment, the mobile multi-function device 900 serves to store a plurality of media items (e.g., songs) in the file system 904. When a user desires to have the mobile multi-function device play a particular media item, a list of available media items is displayed on the display 910. Then, using the user input device 908, a user can select one of the available media items. The processor 902, upon receiving a selection of a particular media item, can supply the media data (e.g., audio file) for the particular media item to a coder/decoder (CODEC) 912. The CODEC 912 can then produces analog output signals for a speaker 914. The speaker 914 can be a speaker internal to the mobile multi-function device 900 or external to the mobile multi-function device 900. For example, a headphone or earphone that connects to the mobile multi-function device 900 would be considered an external speaker.

The mobile multi-function device 900 can also includes a bus interface 916 that couples to a data link 918. The data link 918 can allow the mobile multi-function device 900 to couple to a host device (e.g., host computer or power source). The data link 918 can also provide power to the mobile multi-function device 900.

The portable electronic device utilized herein can, for example, correspond to a computing device (e.g., personal computer), mobile phone (e.g., cellular phone), personal digital assistant (PDA), media player (e.g., music, videos, games, images), media storage device, camera, remote control, and/or the like. The electronic device may also be a multi-functional device that combines two or more of these device functionalities into a single device. A few examples of multi-functional devices can be found in U.S. Patent Application Publication No. 20060197753, entitled “MULTI-FUNCTIONAL HAND-HELD DEVICE”, which is herein incorporated by reference.

The portable electronic device utilized herein can further be a hand-held electronic device. The term hand-held generally means that the electronic device has a form factor that is small enough to be comfortably held in one hand. A hand-held electronic device may be directed at one-handed operation or two-handed operation. In one-handed operation, a single hand is used to both support the device as well as to perform operations with the user interface during use. In two-handed operation, one hand is used to support the device while the other hand performs operations with a user interface during use or alternatively both hands support the device as well as perform operations during use. In some cases, the hand-held electronic device is sized for placement into a pocket of the user. By being pocket-sized, the user does not have to directly carry the device and therefore the device can be taken almost anywhere the user travels (e.g., the user is not limited by carrying a large, bulky and often heavy device).

Digital media assets (i.e., digital media items) can pertain to video items (e.g., video files, movies or games), audio items (e.g., audio files or audio tracks, such as for songs (music) or audiobooks), or image items (e.g., photos). The digital media assets can also include or be supplemented by text or multimedia files.

The various aspects, features, embodiments or implementations of the invention described above can be used alone or in various combinations.

The invention is preferably implemented by software, hardware, or a combination of hardware and software. The invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The advantages of the invention are numerous. Different aspects, embodiments or implementations may, but need not, yield one or more of the following advantages. One advantage of the invention is that limited size display screens are able to be used efficiently and effectively. Another advantage is that media collection representations can be automatically presented on a display screen. Still another advantage of the invention is that digital assets are able to be visually browsed. Yet still another advantage of the invention is that groupings (e.g., clusters) of digital assets can be used to organize digital assets for presentation. When being presented, certain of the digital assets within a grouping can be emphasized. For example, visual representations of these certain digital assets can be presented when the grouping is presented and can also serve to visually represent the content of the grouping.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. An electronic system, comprising:
a memory configured to store a plurality of digital media assets;
a user input device configured to receive a user input;
a display device configured to present media information; and
a processing unit configured to
present any of the digital media assets in response to a user input received via said user input device,
arrange the digital media assets into groups, each group including at least two of the digital media assets, and
cause said display device to present the groups of the digital media assets, wherein visual representations associated with a plurality of the digital media assets within each of the groups are at least partially displayed in a concurrent fashion with partial overlap.

2. An electronic system as recited in claim 1, wherein said processor causes said display device to dynamically and sequentially present the visual representations of the digital media assets for the different ones of the groups.

3. An electronic system as recited in claim 1, wherein the digital media assets are digital audio recordings, and wherein the visual representations are artwork graphics respectfully associated with the digital audio recordings.

4. An electronic system as recited in claim 1, wherein the digital media assets are digital photos, and wherein the visual representations are graphical renderings of with the photos.

5. An electronic system as recited in claim 1, wherein the electronic device is a mobile electronic device.

6. An electronic system as recited in claim 5, wherein the mobile electronic device is a handheld device.

7. An electronic system as recited in claim 1, wherein the mobile electronic device comprises a digital media playback device.

8. An electronic system as recited in claim 1, wherein said memory further stores grouping criteria, and wherein said processor arranges the digital media assets into groups in accordance with the grouping criteria.

9. A method for forming media asset clusters presenting digital assets on a display associated with an electronic device, said method comprising:
identifying a plurality of available digital assets;
obtaining cluster attributes; and
forming media asset clusters from the media asset files based on the cluster attributes, each of the media asset clusters having more than one of the digital assets.

10. A method as recited in claim 9, wherein the available digital assets correspond to a plurality of digital asset files stored on the electronic device.

11. A method as recited in claim 9, wherein the electronic device is a computing device.

12. A method as recited in claim 9, wherein the electronic device is a mobile electronic device.

13. A method as recited in claim 9, wherein the digital assets are digital media assets, and wherein the clusters are media assets clusters.

14. A method as recited in claim 9, wherein at least one of the cluster attributes pertains to an event.

15. A method as recited in claim 9, wherein at least one of the cluster attributes is selected from the group of date, time or location.

16. A method for importing digital media assets to an electronic device, said method comprising:
receiving digital media assets being imported to the electronic device;
automatically associating the received digital media assets to media asset clusters, thereby determining cluster information; and
storing the imported digital media assets and the cluster information to the electronic device.

17. A method as recited in claim 16, wherein said associating of the received digital media assets to the media asset clusters is based on at least one of date, time or location for the received digital media assets.

18. A method for presenting digital media assets on a display associated with a computing device, said method comprising:
identifying a plurality of media assets corresponding to a plurality of media assets files stored on the computing device;
obtaining cluster attributes;
forming media asset clusters from the media assets based on the cluster attributes, each of the media asset clusters corresponding to more than one of the media assets;
determining a presentation format for the media asset clusters; and
dynamically presenting the media asset clusters in accordance with the presentation format respectively associated with the media asset clusters.

19. A method as recited in claim 18, wherein during said presenting the media asset clusters are sequentially displayed on the display.

20. A method as recited in claim 19, wherein the media asset clusters transition across the display.

21. A method as recited in claim 19, wherein the media asset clusters transition in an animated manner across the display.

22. A method as recited in claim 18, wherein said presenting comprises animating transitions from display of a first of the media asset clusters to display of a second of the media asset clusters.

23. A method as recited in claim 18, wherein the presentation format causes a subset of the media assets of the media asset cluster to be displayed with one or more of the media assets within the subset of the media asset cluster being overlapped.

24. A method as recited in claim 18, wherein said presenting of the media asset clusters displays visual representations for the media asset clusters such that the visual representation for the media asset clusters automatically move across the display one after another.

25. A method as recited in claim 18, wherein the presentation format is dependent on the number of media assets within the media asset cluster.

26. A method as recited in claim 18,
wherein the presentation format for at least one of the media asset clusters includes at least a first visual representation for a first media asset, a second visual representation for a second media asset, and a third visual representation for a third media asset, and
wherein said presenting of the at least one of the media asset clusters concurrently displays at least a portion of each of the first visual representation, the second visual representation and the third visual representation.

27. A method as recited in clam 26, wherein said presenting displays the first visual representation such that it partially obscures display of the second visual representation and the third visual representation.

28. A method as recited in claim 18, wherein said presenting comprises:
(e1) selecting a set of media assets from the media assets that are associated with one of the media asset clusters to be presented; and
(e2) displaying a visual representation of the set of media assets in accordance with the presentation format.

29. A method as recited in claim 28, wherein the number of the media assets in the set of media assets is dependent on the presentation format.

30. A method as recited in claim 18, wherein said presenting comprises:
selecting a first subset of media assets from the media assets that are associated with one of the media asset clusters to be displayed;
displaying a first representation of the first subset of media assets in accordance with the presentation format;
selecting a second subset of media assets from the media assets that are associated with one of the media asset clusters to be displayed, the second subset of media assets being different from the first subset of media assets; and
subsequent to said displaying of the first representation of the first subset of media assets, displaying a second visual representation of the second subset of media assets in accordance with the presentation format while no longer displaying the first representation of the first set of media assets.

31. A computer readable medium including at least executable computer program code tangibly stored thereon for presenting digital media assets on a display associated with an electronic device, said computer readable medium comprising:
computer program code for identifying a plurality of media assets corresponding to a plurality of media assets files stored on the computing device;
computer program code for obtaining cluster attributes;
computer program code for forming media asset clusters from the media assets based on the cluster attributes, each of the media asset clusters corresponding to more than one of the media assets;
computer program code for determining a presentation format for the media asset clusters; and
computer program code for dynamically presenting the media asset clusters in accordance with the presentation format respectively associated with the media asset clusters.

32. A method for displaying information on digital assets, said method comprising:
identifying a plurality of clusters to be displayed, each of the clusters corresponding to a plurality of digital assets;
selecting one of the clusters to be displayed;
displaying an initial representation of the selected cluster;
determining, following said displaying of the initial representation of the selected cluster, whether another representation of the selected cluster should be displayed;
displaying the another representation of the selected cluster if it is determined that the another representation of the selected cluster should be displayed.

33. A method as recited in claim 32, wherein the another representation of the selected cluster pertains to digital assets within the selected cluster that are not part of the initial representation.

34. A method as recited in claim 32, wherein said method further comprises:
determining, following said displaying of the initial representation of the selected cluster, whether another one of the clusters should be displayed;
selecting another one of the clusters to be displayed;
displaying an initial representation of the another cluster;
determining, following said displaying of the initial representation of the another cluster, whether another representation of the another cluster should be displayed; and
displaying the another representation of the another cluster if it is determined that the another representation of the another cluster should be displayed.

35. A method as recited in claim 32, wherein the digital assets are digital media assets.
